(19) United States
(12) Patent Application Publication
(10) Pub. No.: US 2003/0143141 A1
(43) Pub. Date: Jul. 31, 2003

(54) Method for removal of nox and n2o

(76) Inventors: Meinhard Schwefer, Mesdrede (DE); Erich Szonn, Witten (DE)

Correspondence Address: CONNOLLY BOVE LODGE & HUTZ, LLP, 1220 N MARKET STREET, P O BOX 2207, WILMINGTON, DE, 19899

(21) Appl. No.: 10/181,086

(22) PCT Filed: Jan. 9, 2001
(86) PCT No.: PCT/EP01/00156

(30) Foreign Application Priority Data
Jan. 14, 2000 (DE) 100 01 539.5

(51) Int. Cl. B01D 53/56

(52) U.S. Cl. 423/235; 422/172; 422/177; 423/237

(57) ABSTRACT

An apparatus and a process are described for reducing the content of NOₓ and N₂O in process gases and waste gases. The apparatus encompasses at least one catalyst bed comprising a catalyst which is substantially composed of one or more iron-loaded zeolites, and two reaction zones, where the first zone (reaction zone I) serves for decomposing N₂O and in the second zone (reaction zone II) NOₓ is reduced, and, located between the first and second zone, there is an apparatus for the introduction of NH₃ gas.

Many processes, e.g. combustion processes, and the industrial production of nitric acid produce waste gas loaded with nitrogen monoxide NO, nitrogen dioxide N₂O (together termed NOₓ), and also nitrous oxide N₂O. While NO and N₂O have long been recognized as compounds with ecotoxic relevance (acid rain, smog formation) and limits have been set worldwide for the maximum permissible emissions of these materials, the focus of environmental protection has in recent years increasingly also been directed toward nitrous oxide, since it makes a not inconsiderable contribution to the decomposition of stratospheric ozone and to the greenhouse effect. For environmental protection reasons there is therefore an urgent requirement for technical solutions which eliminate nitrous oxide emissions together with NOₓ emissions.

There are numerous known methods for the separate elimination of N₂O on the one hand and on the other hand.

An NOₓ reduction method which should be highlighted is selective catalytic reduction (SCR) of NOₓ by means of ammonia in the presence of vanadium-containing TiO₂ catalysts (cf., for example, G. Ertl, H. Knözinger J. Weltkamp: Handbook of Heterogeneous Catalysis, Vol. 4, pages 1633-1668, VCH Weinheim (1997)). Depending on the catalyst, this reduction can proceed at temperatures of from about 150 to about 450° C., and permits more than 90% NOₓ decomposition. It is the most-used technique for reducing the amount of NOₓ in waste gases from industrial processes.

There are also processes based on zeolite catalysts for the reduction of NOₓ, using a very wide variety of reducing agents. Alongside Cu-exchanged zeolites (cf., for example, EP-A-0914866), iron-containing zeolites appear to be of special interest for practical applications.

For example, U.S. Pat. No. 4,571,329 claims a process for the reduction of NOₓ in a gas which is composed of at least 50% of NO₂, by means of ammonia in the presence of an Fe zeolite. The ratio of NH₃ to N₂O is at least 1.3. In the process described in that specification, NOₓ-containing gases are to be reduced by ammonia, without formation of N₂O as by-product.

U.S. Pat. No. 5,451,387 describes a process for the selective catalytic reduction of NOₓ by NH₃ over iron-exchanged zeolites at temperatures around 400° C.

Whereas industry has many years of experience with the reduction of NOₓ content in waste gases, for N₂O elimination there are only a few technical processes which are mainly directed toward thermal or catalytic decomposition of N₂O. Kapteijn et al. (Kapteijn F. et al., Appl. Cat. B: Environmental 9 (1996) 25-64) gives an overview of the catalysts which have been demonstrated to be suitable in principle for the decomposition and reduction of nitrous oxide.

Among these, Fe and Cu zeolite catalysts appear to be particularly suitable, and either bring about simple decomposition of the N₂O into N₂ and O₂ (U.S. Pat. No. 5,171,553) or else serve for catalytic reduction of N₂O with the aid of NH₃ or of hydrocarbons to give N₂ and H₂O or CO₂.

For example, JP-A-07 060 126 describes a process for the reduction of N₂O by NH₃ in the presence of iron-containing zeolites of pentasil type at temperatures of 450° C. The N₂O decomposition achievable by this process is 71%.

Mauvezin et al., in Catal. Lett. 62 (1999) 41-44, give an overview relevant to this topic and concerning the suitability of various iron-exchanged zeolites of type MOR, MFI, BEA, FER, FAU, MAZ, and OFF. According to this, only in the case of Fe-BEA can more than 90% N₂O reduction be achieved through NH3 addition below 500° C.

For reasons of simplicity and cost-effectiveness, a single-stage process is particularly desirable, i.e. the use of a single catalyst for the reduction of both NOₓ and N₂O.

Although the reduction of NOₓ by ammonia can proceed in the presence of Fe zeolites at temperatures below 400° C., temperatures >500° C. are generally required, as mentioned, for N₂O reduction.

This is a disadvantage not only because the heating of the waste gases to these temperatures implies additional energy consumption, but especially because the zeolite catalysts used are not resistant to aging under these conditions in the presence of water vapor.

Relatively recent publications therefore describe the reduction of N₂O and NOₓ in the presence of hydrocarbons, using iron-containing zeolites as catalyst. Although the reduction temperature for N₂O can be lowered here at temperatures <450° C., only moderate conversions (maximum <50%) are achieved for NOₓ reduction (Kögel et al., J. Catal. 182 (1999)).

A very recent patent application (JP-A-09 000 884) claims the simultaneous use of ammonia and hydrocarbons. Here, the hydrocarbons selectively reduce the N₂O present in the waste gas, while NOₓ reduction is brought about by the ammonia added. The entire process can be operated at temperatures <450° C. However, reaction of the N₂O with the hydrocarbon produces a not inconsiderable amount of toxic carbon monoxide, which necessitates further purification of the waste gas. In order very substantially to avoid CO formation, the use of a downstream Pt/Pd catalyst is proposed.

Additional doping of the iron-containing zeolite catalyst with Pt is known from Kögel et al., Chemie Ingenieur Technik 70 (1998) 1164.

WO-A-00/48715, unpublished at the priority date of the present invention, describes a process in which a waste gas which comprises NOₓ and N₂O is passed over an iron zeolite catalyst of beta type at temperatures of from 200 to 600° C., where the waste gas also comprises NH₃ in a quantitative proportion of from 0.7 to 1.4, based on the total amount of NOₓ and N₂O. NH₃ serves here as reducing agent both for NOₓ and for N₂O. Although the process operates as a single-stage process at temperatures below 500° C., it, like the abovementioned processes, has the fundamental disadvantage that an approximately equimolar amount of reducing agent (here NH₃) is needed to eliminate the N₂O content.

It is an object of the present invention to provide a simple but cost-effective process which as far as possible uses only one catalyst and which delivers good conversions both for NOx decomposition and for N₂O decomposition, and consumes a minimal amount of reducing agent, and generates no downstream by-products which are environmentally hazardous.

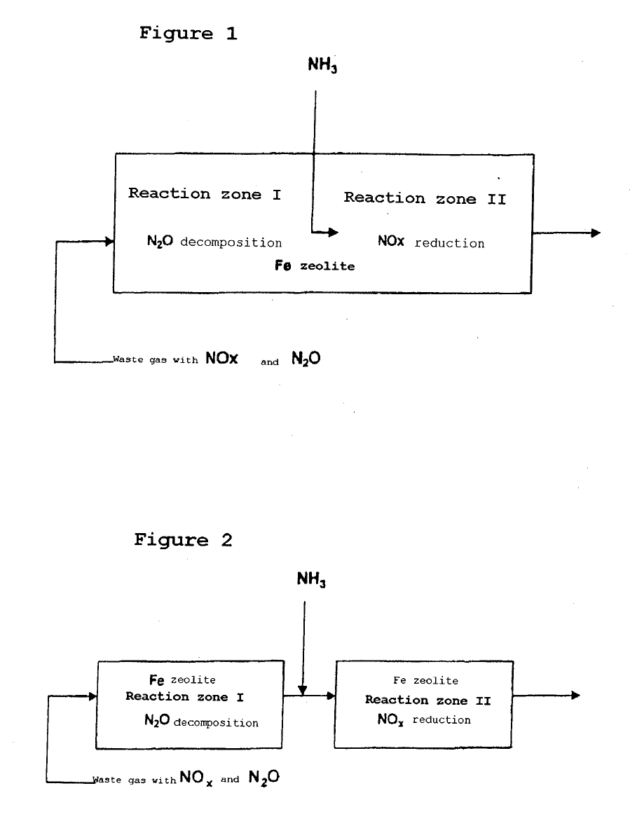

This object is achieved by means of the present invention. The present invention provides a process for reducing the content of NOₓ and N₂O in process gases and waste gases, where the process is carried out in the presence of a catalyst, preferably a single catalyst, which is substantially composed of one or more iron-loaded zeolites, and, to remove N₂O, a first step passes the gas comprising N₂O and NOₓ over the catalyst in a reaction zone I at a temperature <500° C., and a second step conducts the resultant gas stream onward over an iron-containing zeolite catalyst in a reaction zone II, a proportion of NH₃ adequate for the reduction of the NOₓ being added to the gas stream (cf. FIG. 1).

The achievement of this low decomposition temperature for N₂O is rendered possible by the presence of NOₓ. It has been found that NOₓ is an activator accelerating N₂O decomposition in the presence of iron-containing zeolites.

For stoichiometric amounts of N₂O and NO, this effect has been described by Kapteijn F.; Mul, G.; Marban, G.; Rodriguez-Mirasol, J.; Moulijn, J. A., Studies in Surface Science and Catalysis 101 (1996) 641-650, and has been attributed to the reaction of N₂O with NO as given by

NO+N₂O→NO₂+N₂.

However, since it has now been found that iron-containing zeolites also catalyze the decomposition of the NO₂ formed as given by

2NO₂ [symbol] 2 NO+O₂

even substoichiometric amounts of NOx are sufficient to accelerate N₂O decomposition. An effect which becomes markedly more pronounced as the temperature increases. When other catalysts are used there is no cocatalytic action of NO on N₂O decomposition.

The process of the invention permits both the decomposition of N₂O and the reduction of NOₓ to be carried out at a uniformly low operating temperature. This was not possible hitherto using the processes described in the prior art.

The use of iron-containing zeolites, preferably those of MFI type, in particular Fe-ZSM-5, permits the decomposition of N₂O as in the above reaction equations in the presence of NOₓ even at temperatures at which decomposition of N₂O would not take place at all without NOₓ.

In the process of the invention, the content of N₂O after leaving the first reaction zone is in the range from 0 to 200 ppm, preferably in the range from 0 to 100 ppm, in particular in the range from 0 to 50 ppm.

Another embodiment of the invention provides an apparatus for reducing the content of NOₓ and N₂O in process gases and waste gases, encompassing at least one catalyst bed comprising a catalyst which is substantially composed of one or more iron-loaded zeolites, and two reaction zones, where the first zone (reaction zone I) serves for decomposing N₂O and in the second zone (reaction zone II) NOx is reduced, and, located between the first and second zone, there is an apparatus for the introduction of NH₃ gas (cf. FIGS. 1 and 2).

For the purposes of the invention, the catalyst bed may be designed as desired. Its form may, for example, be that of a tubular reactor or a radially arranged basket reactor. For the purposes of the invention, there may also be spatial separation of the reaction zones, as shown in FIG. 2.

Catalysts used according to the invention are substantially composed, preferably to an extent of >50% by weight, in particular >70% by weight, of one or more iron-loaded zeolites. For example, alongside an Fe-ZSM-5 zeolite there may be another iron-containing zeolite present in the catalyst used according to the invention, e.g. an iron-containing zeolite of the MFI type of MOR type. The catalyst used according to the invention may moreover comprise other additives known to the skilled worker, e.g. binders. Catalysts used according to the invention are preferably used on zeolites into which iron has been introduced via solid-phase ion exchange. The usual starting materials here are the commercially available ammonium zeolites (e.g. NH₄-ZSM-5) and the appropriate iron salts (e.g. FeSO₄×7 H₂O), these being mixed intensively with one another by mechanical means in a bead mill at room temperature. (Turek et al.; Appl. Catal. 184, (1999) 249-256; EP-A-0 955 080). These citations are expressly incorporated herein by way of reference. The resultant catalyst powders are then calcined in a furnace in air at temperatures in the range from 400 to 600° C. After the calcination process, the iron-containing zeolites are thoroughly washed in distilled water, and the zeolites are filtered off and dried. The resultant iron-containing zeolites are finally treated with the appropriate binders and mixed, and extruded to give, for example, cylindrical catalyst bodies. Suitable binders are any of the binders usually used, the most commonly used here being aluminum silicates, e.g. kaolin.

According to the present invention, the zeolites which may be used are iron-loaded zeolites. The iron content here, based on the weight of zeolite, may be up to 25%, but preferably from 0.1 to 10%. The iron-loaded zeolites contained in the catalyst are preferably of the types MFI, BEA, FER, MOR, and/or MEL.

Precise details concerning the build or structure of these zeolites are given in the Atlas of Zeolite Structure Types, Elsevier, 4th revised Edition 1996, which is expressly incorporated herein by way of reference. According to the invention, preferred zeolites are of MFI (pentasil) type or MOR (mordenite) type. Particular preference is given to zeolites of the Fe-ZSM-5 type.

There may be a spatial connection between the reaction zone I and reaction zone II, as shown in FIG. 1, so that the gas loaded with nitrogen oxides is continuously passed over the catalyst, or else there may be spatial separation between them, as is seen in FIG. 2.

Iron-containing zeolites are used in the process of the invention in reaction zones I and II. These catalysts in the respective zones may be different, or preferably the same.

If there is spatial separation of the reaction zones it is possible for the temperature of the second zone or of the gas stream entering into that zone to be adjusted via dissipation or supply of heat in such a way that it is lower or higher than that in the first zone.

According to the invention, the temperature of reaction zone I, in which nitrous oxide is decomposed, is <500° C., preferably in the range from 350 to 500° C. The temperature of reaction zone II is preferably the same as that of reaction zone I.

The process of the invention is generally carried out at a pressure in the range from 1 to 50 bar, preferably from 1 to 25 bar. The feed of the NH₃ gas between reaction zone I and II, i.e. downstream of reaction zone I and upstream of reaction zone II, takes place via a suitable apparatus, e.g. an appropriate pressure valve or appropriately designed nozzles.

The space velocity with which the gas loaded with nitrogen oxides is usually passed over the catalyst is, based on the total catalyst volume in both reaction zones, from 2 to 200,000 h⁻¹, preferably from 5000 to 100,000 h⁻¹.

The water content of the reaction gas is preferably in the region of <25% by volume, in particular in the region <15% by volume. A low water content is generally preferable.

A high water content is less significant for NOₓ reduction in reaction zone II, since high NOx decomposition rates are achieved here even at relatively low temperatures.

A relatively low concentration of water is generally preferred in reaction zone I, since a very high water content would require high operating temperatures (e.g. >500° C.). Depending on the zeolite type used and the operating time, this could exceed the hydrothermal stability limits of the catalyst. However, the NOₓ content plays a decisive part here, since this can counteract the deactivation by water, as described in German Application 100 01 540.9, which is of even priority date and was unpublished at the priority date of the present invention.

The presence of CO₂, and also of other deactivating constituents of the reaction gas which are known to the skilled worker, should be minimized wherever possible, since these would have an adverse effect on N₂O decomposition.

All of these influences, and also the selected catalyst loading, i.e. space velocity, have to be taken into account when selecting a suitable operating temperature for the reaction zones. The skilled worker is aware of the effect of these factors on N₂O decomposition rate and will take them into account appropriately on the basis of his technical knowledge.

The process of the invention permits N₂O and NOₓ to be decomposed at temperatures <500° C., preferably <450° C., to give N₂, O₂, and H₂O, without formation of environmentally hazardous by-products, e.g. toxic carbon monoxide, which would itself have to be removed. The reducing agent NH3 is consumed here for the reduction of NOₓ, but not, or only to an insubstantial extent, for the decomposition of N₂O.

The conversions achievable by the present process for N₂O and NOₓ are >80%, preferably >90%. This makes the process markedly superior to the prior art in its performance, i.e. the achievable conversion levels for N₂O and NOₓ decomposition, and also in its operating costs and investment costs.

The example below illustrates the invention:

An iron-loaded zeolite of type ZSM-5 is used as catalyst. The Fe-ZSM-5 catalyst was prepared by a solid-phase ion exchange, starting from a commercially available ammonium-form zeolite (ALSI-PENTA, SM27). Detailed information concerning the preparation may be found in: M. Rauscher, K. Kesore, R. Mönnig, W. Schwieger, A. Tiβler, T. Turek: Preparation of highly active Fe-ZSM-5 catalyst through solid state ion exchange for the catalytic decomposition of N₂O in Appl. Catal. 184 (1999) 249-256.

The catalyst powders were calcined in air for 6 h at 823K, washed, and dried overnight at 383K. Addition of appropriate binders was followed by extrusion to give cylindrical catalyst bodies, which were broken to give granules whose grain size was from 1 to 2 mm.

The apparatus for reducing NOₓ content and N₂O content comprised two tubular reactors installed in series, each of which had been charged with an amount of the above catalyst such that, based on the incoming gas stream, the resultant space velocity was in each case 10,000 h⁻¹. NH₃ gas was added between the two reaction zones. The operating temperature of the reaction zones was adjusted by heating. An FTIR gas analyzer was used for analysis of the incoming and outgoing gas stream into the apparatus.

At incoming concentrations of 1000 ppm of N₂O, 1000 ppm of NOₓ, 2500 ppm of H₂O, and 2.5% by volume of O₂ in N₂, and with intermediate addition of NH₃, the conversion results listed in the following table for N₂O, NOₓ, and NH₃ were obtained at a uniform operating temperature of 400° C.

TABLE

| | Incoming | Outgoing | |
|---|---|---|---|
| | concentration | concentration | Conversion |
| N₂O | 1000 ppm | 39 ppm | 96.1% |
| NOₓ (x = 1-2) | 1000 ppm | 78 ppm | 92.2% |
| NH₃ | 1200 ppm*⁾ | 0 ppm | 100% |

*⁾Added between first and second reaction zone

What is claimed is:

1. An apparatus for reducing the content of NOₓ and N₂O in process gases and waste gases, encompassing at least one catalyst bed divided into two reaction zones and comprising a catalyst which is substantially composed of one or more iron-loaded zeolites, where the first zone (reaction zone I) serves for decomposing N₂O and in the second zone (reaction zone II) NOₓ is reduced, and, located between the first and second zone, there is an apparatus for the introduction of NH₃ gas.

2. The apparatus as claimed in claim 1, characterized in that reaction zone I and reaction zone II use the same catalysts.

3. The apparatus as claimed in claim 1, characterized in that there is a spatial separation between reaction zone I and reaction zone II.

4. The apparatus as claimed in claim 1, characterized in that there is a spatial connection between reaction zone I and reaction zone II.

5. The apparatus as claimed in at least one of the preceding claims, characterized in that the iron-loaded zeolite(s) present in the catalyst is/are of the type MFI, BEA, FER, MOR and/or MEL.

6. The apparatus as claimed in at least one of the preceding claims, characterized in that the iron-loaded zeolite(s) is/are of the type MFI.

7. The apparatus as claimed in at least one of the preceding claims, characterized in that the zeolite is an Fe-ZSM-5.

8. A process for reducing the content of NOₓ and N₂O in process gases and waste gases, where the process is carried out the presence of a catalyst which is substantially composed of one or more iron-loaded zeolites, and, to remove N₂O, a first step passes the gas comprising N₂O and NOₓ over the catalyst in a reaction zone I at a temperature <500° C., and a second step conducts the resultant gas stream onward over an iron-containing zeolite catalyst in a reaction zone II, a proportion of NH₃ adequate for the reduction of the NOₓ being added to the gas stream prior to its entry into reaction zone II.

9. The process as claimed in claim 8, characterized in that reaction I and II use the same catalyst.

10. The process as claimed in claim 8, characterized in that the iron-loaded zeolite(s) present in the catalyst is/are of the type MFI, BEA, FER, MOR, and/or MEL.

11. The process as claimed in claim 10, characterized in that the iron-loaded zeolite is of the type MFI.

12. The process as claimed in claim 11, characterized in that the zeolite is a Fe-ZSM-5.

13. The process as claimed in one or more of claims 8 to 12, characterized in that there is a spatial separation between reaction zones I and II.

14. The process as claimed in one or more of claims 8 to 12, characterized in that there is a spatial connection between reaction zones I and II.

15. The process as claimed in one or more of claims 8 to 14, characterized in that the process is carried out at a pressure in range from 1 to 50 bar.
